(19) United States
(12) Patent Application Publication
(10) Pub. No.: US 2006/0290512 A1
(43) Pub. Date: Dec. 28, 2006

(54) Methods and apparatus for RFID transponder fabrication

(75) Inventor: Kenneth Shanton, West Chicago, IL (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: Smurfit-Stone Container Enterprises, Inc.

(21) Appl. No.: 11/158,612

(22) Filed: Jun. 22, 2005

(51) Int. Cl. G08B 13/14

(52) U.S. Cl. 340/572.7

(57) ABSTRACT

Methods and apparatus for fabricating radio-frequency identification (RFID) transponders are provided. The apparatus radio-frequency identification (RFID) transponder includes a container substrate, an interposer that includes an interposer substrate, at least one electrically conductive lead coupled to the interposer substrate, and a radio frequency identification circuit electrically coupled to the at least one interposer lead; and a printed antenna communicatively coupled to the at least one interposer lead, the printed antenna including electrically conductive ink, at least a portion of the printed antenna coupled to the container substrate, the antenna configured to receive radio frequency energy from an RFID reader and radiate radio frequency energy received from the radio frequency identification circuit.

### BACKGROUND OF THE INVENTION

This invention relates generally to wireless communication systems and, more particularly, to container structures that incorporate radio frequency identification (RFID) components.

At least some known RFID systems include a transponder, an antenna, and a transceiver with a decoder, or a reader. The transponder typically includes a radio frequency integrated circuit, and an antenna positioned on a substrate, such as an inlet or tag. The antenna receives RF energy from the reader wirelessly and transmits the data encoded in the received RF energy to the radio frequency integrated circuit.

RF transponder “readers” utilize an antenna as well as a transceiver and decoder. When a transponder passes through an electromagnetic zone of a reader, the transponder is activated by the signal from the antenna. The reader decodes the data on the transponder and this decoded information is forwarded to a host computer for processing. Readers or interrogators can be fixed, mobile or handheld devices, depending on the particular application.

Several different types of transponders are utilized in RFID systems, including passive, semi-passive, and active transponders. Each type of transponder may be read only or read/write capable. Passive transponders obtain operating power from the radio frequency signal of the reader that interrogates the transponder. Semi-passive and active transponders are powered by a battery, which generally results in a greater read range. Semi-passive transponders may operate on a timer and periodically transmit information to the reader. Transponders may also be activated when they are read or interrogated by a reader. Transponders may control their output, which allows them to activate or deactivate apparatus remotely. Active transponders can initiate communication, whereas passive and semi-passive transponders are activated only when they are read by another device first. Active transponders can supply instructions to a machine that then reports its performance to the transponder. Multiple transponders may be located in a radio frequency field and read individually or simultaneously. Sensors may be coupled to the transponders to sense an environmental condition.

Transponders typically are attached to an article, such as a corrugated box or a folding carton, in the form of a smart label or tag that includes a radio frequency integrated circuit, an antenna, and a backing substrate, usually polyester or paper, together with a release layer. The assembled label may then be attached to the article by means of a pressure-sensitive adhesive that is incorporated into the label.

Adhesives typically used to couple the radio frequency integrated circuit to the antenna comprise an anisotropic conductive film (ACF) or anisotropic conductive adhesive (ACA) to bond the chip to the antenna. Alternatively, a metal “strap” of an interposer is crimped to the antenna or the strap may be ultrasonically bonded to the antenna.

The use of ACA/ACF has also been used for coupling radio frequency integrated circuits with integral straps to antennas. The antennas may be fabricated by etching a metallic foil attached to a polyester substrate or may be printed using aluminum, copper and/or silver inks. The antennas may also be formed by hot or cold stamping of a metal foil such as aluminum or copper or composites.

The above described methods are specialized and expensive means of attachment of the radio frequency integrated circuit chip to an antenna. Further, heat and or pressure may be required to be applied for approximately ten to approximately fifteen seconds to cure the adhesive. A procedure requiring this amount of time to complete the operation may be acceptable in some applications, however such a procedure is not be cost-effective for mass application of RFID transponders to a large quantity of articles in a global supply chain.

### BRIEF DESCRIPTION OF THE INVENTION

In one embodiment, a radio-frequency identification (RFID) transponder assembly includes a container substrate, an interposer that includes an interposer substrate, at least one electrically conductive lead coupled to the interposer substrate, and a radio frequency identification circuit electrically coupled to the at least one interposer lead. The radio-frequency identification (RFID) transponder assembly further includes a printed antenna communicatively coupled to the at least one interposer lead wherein the printed antenna includes electrically conductive ink and at least a portion of the printed antenna is coupled to the container substrate. The antenna is further configured to receive radio frequency energy from an RFID reader and radiate radio frequency energy received from the radio frequency identification circuit.

In another embodiment, a radio-frequency identification (RFID) enabled product container includes a container external surface, an interposer that includes an interposer substrate, at least one electrically conductive lead coupled to the interposer substrate, and a radio frequency identification circuit electrically coupled to the at least one interposer lead. The container further includes a printed antenna communicatively coupled to the at least one interposer lead, the printed antenna including electrically conductive ink, the antenna configured to receive radio frequency energy from an RFID reader and radiate radio frequency energy received from the radio frequency identification circuit.

In yet another embodiment, a method of forming an RFID transponder includes coupling an interposer to a container substrate, wherein the interposer includes an interposer substrate, a radio frequency identification circuit having at least one electrical contact extending from a first surface of the radio frequency identification circuit. The radio frequency identification circuit is coupled to the interposer substrate such that the at least one electrical contact is oriented away from the interposer substrate. The interposer further includes an interposer lead communicatively coupled to the at least one electrical contact and the interposer lead extending to an area of the interposer substrate away from the radio frequency identification circuit. The method further includes printing an antenna over at least a portion of the interposer lead such that the antenna and the radio frequency identification circuit are communicatively coupled.

### BRIEF DESCRIPTION OF THE DRAWINGS

FIG. 1 is a perspective view of an exemplary radio frequency identification (RFID) interposer;

FIG. 2 is a schematic view of an exemplary RF-enabled transponder assembly that may be used with the interposer shown in FIG. 1; and

FIG. 3 is a flowchart of an exemplary method of forming the radio frequency identification (RFID) transponder assembly shown in FIG. 2.

### DETAILED DESCRIPTION OF THE INVENTION

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

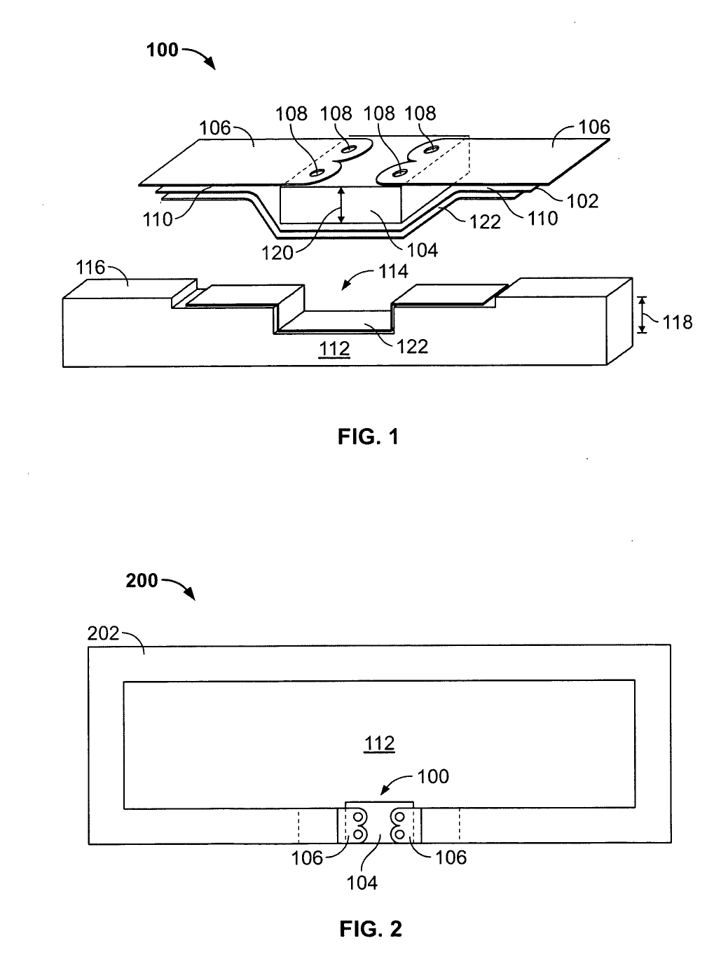

FIG. 1 is a perspective view of an exemplary radio frequency identification (RFID) interposer 100 in accordance with an embodiment of the present invention. In the exemplary embodiment, interposer 100 includes an interposer substrate 102, a radio frequency identification circuit 104, at least one electrically conductive lead 106 coupled to interposer substrate 102.

Interposer substrate 102 is fabricated from a thin film type insulating material, for example, but not limited to, high Tg polycarbonate, polyethylene terephthalate (PET), polyarylate, polysulfone, a norbornene copolymer, poly phenylsulfone, polyetherimide, polyethylenenaphthalate (PEN), polyethersulfone (PES), polycarbonate (PC), a phenolic resin, polyester, polyimide, polyetherester, polyetheramide, cellulose acetate, aliphatic polyurethanes, polyacrylonitrile, polytrifluoroethylenes, polyvinylidene fluorides, HDPEs, poly(methyl methacrylates), a cyclic or acyclic polyolefin, or paper. Radio frequency identification circuit 104 and electrically conductive lead 106 is coupled to interposer substrate 102 using an adhesive or is bonded to interposer substrate 102 using another known method.

Radio frequency identification circuit 104 may include a plurality of protruding bumps 108 bonded to a surface of the chip and electrically coupled to radio frequency identification circuit 104. Electrically conductive leads 106 are electrically coupled to bumps 108 using an anisotropically conductive adhesive (ACA). Bumps 108 are, for example nickel/gold bumps or stud bumps. The ACA may have conductive particles dispersed in a binder, such as an anisotropically conductive film (ACF) or an anisotropically conductive paste (ACP). An isotropically conductive adhesive may also be used, but because the electrical connection will conduct in any direction, the isotropically conductive adhesive may require discrete placement at individual bond sites.

In the exemplary embodiment, radio frequency identification circuit 104 is a passive circuit. In various alternative embodiments, radio frequency identification circuit 104 is a semi-passive or active circuit that includes a battery (not shown) or capacitive storage device coupled to radio frequency identification circuit 104. In various embodiments, a sensor (not shown) is electrically coupled to radio frequency identification circuit 104 for communicating environmental data proximate the sensor. The sensor is of micro-mechanical design such that the sensor is incorporated into radio frequency identification circuit 104 or is a separate device that is communicatively coupled to radio frequency identification circuit 104. The sensor is used to read environmental or other conditions in the vicinity of the sensor, for example, but not limited to, vibration, shock, temperature, pressure, and humidity. A plurality of sensors are coupled to each radio frequency identification circuit 104. In one embodiment, the sensors are configured to read and transmit a signal corresponding to the environmental conditions when signaled by an RF reader. In various alternative embodiments, the sensors may include a battery which permits the sensor to read and record the environmental conditions and transmit the recorded data when requested or interrogated by an RF reader.

Electrically conductive lead 106 is fabricated from, for example, a conductive film, such as metallic foil, a conductive ink trace, or other suitable method to form a conductive path from bumps 108 to an area 110 of interposer substrate 102 that extends away from radio frequency identification circuit 106.

A substrate 112 for fabricating a product container may include a depression 114 embossed into a surface 116 of substrate 112. In the exemplary embodiment, depression 114 includes a negative profile of interposer 100. In an alternative embodiment, depression 114 may include a sloping cross-section or curved cross-section. A depth 118 of depression 114 is approximately equal to a thickness 120 of radio frequency identification circuit 104. In various embodiments, depth 118 is greater than thickness 120 or less than thickness 120.

In the exemplary embodiment, an adhesive 122 is applied to interposer substrate 102. Adhesive 122 is configured to bond interposer 100 to surface 116 at least partially within depression 114. Coupling interposer 100 within depression 114 facilitates ensuring that radio frequency identification circuit 104 is protected within the structure of the substrate such that a possibility of accidental damage to radio frequency identification circuit 104 is reduced. Coupling interposer 100 within depression 114 facilitates locating interposer 100 in a correct position with respect to product container assembly line equipment (not shown). Coupling interposer 100 within depression 114 also facilitates ensuring sufficient bonding engagement of interposer 100 with adhesive 122 and substrate 116. In an alternative embodiment, adhesive 122 is applied to container substrate 112 prior to inserting interposer 100 at least partially within depression 114. Seating of interposer 100 to container substrate 112 is facilitated with light pressure from, for example, an applicator and/or a roller (both not shown in FIG. 1).

In the exemplary embodiment, container substrate 112 is a wall of a fabricated product container or is a component of assembly of a product container, such as a linerboard prior to fabrication into a corrugated structure. Container substrate 112 is fabricated from, for example, cardboard, linerboard, medium, coated or uncoated recycled board, coated or uncoated paper, plastic, and combinations thereof, in a single layer or of multiple layers or plies. Surface 116 is planar or curved, for example, an outer peripheral surface of a round product container.

FIG. 2 is a schematic view of an exemplary RF-enabled transponder assembly 200 that may be used with interposer 100. In the exemplary embodiment, transponder assembly 200 includes interposer 100 adhesively bonded to container substrate 112. An antenna 202 is coupled to container substrate 112 in any of various configurations that are compatible with the radio frequency identification circuit 104 used. Antenna 202 is fabricated of an electrically conductive material, such as a metallic material. Antenna 202 is formed on container substrate by any of various methods. For example, antenna 202 is formed from conductive ink that is printed or otherwise deposited on container substrate 112. Alternatively, antenna 202 is formed from metal deposited on substrate 112 by any of various suitable, known deposition methods, such as vapor deposition. As a further alternative, antenna 202 is part of a web of antenna material (not shown) that is adhered to the substrate 104 by suitable means, for example, by use of a suitable adhesive in a lamination process. The web of a plurality of antennas are made from, for example, copper, silver, aluminum or other thin conductive material, such as etched or hot-stamped metal foil, conductive ink, and sputtered metal. The web of antennas are on a film, coated paper, laminations of film and paper, or other suitable substrate. As yet another alternative, the antenna 202 is formed by selective removal of metal from a metal layer, for example, using known lithography processes. It will be appreciated that other suitable means, for example, electroplating, may be used to form the antenna 106 on the container substrate. In one embodiment, radio frequency identification circuit 104 is applied to substrate 112 using an attach device (not shown) configured to remove a radio frequency identification circuit 104 from, for example, a web carrying a plurality of radio frequency identification circuits 104. In another embodiment, substrate 112, radio frequency identification circuit 104, and antenna 106 are formed as a strap that is applied to an article using a strap attach device (not shown). The attach device and the strap attach device are configured to operate independently of other assembly equipment or may be configured to operate in-line with other assembly equipment in an assembly line.

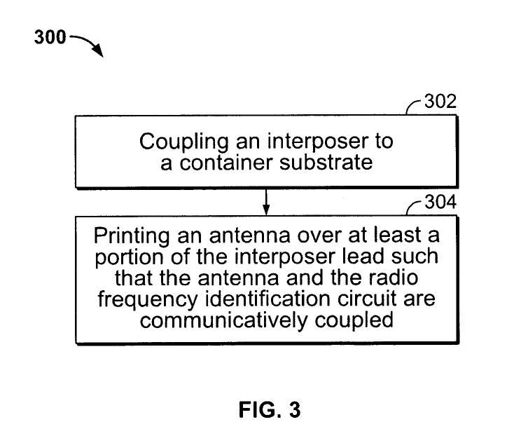

FIG. 3 is a flowchart of an exemplary method 300 of forming radio frequency identification (RFID) transponder assembly 200 (shown in FIG. 2). Method 300 is particularly suited for high speed application of RFID transponder assembly 200 to container substrates used in supply chain packaging materials.

Method 300 includes coupling 302 an interposer to a container substrate. In the exemplary embodiment, the interposer includes an interposer substrate, a radio frequency identification circuit, and an interposer lead.

The radio frequency identification circuit includes at least one electrical contact extending from a first surface of the radio frequency identification circuit and the radio frequency identification circuit is coupled to the interposer substrate such that the at least one electrical contact is oriented away from the interposer substrate. The interposer lead is communicatively coupled to the at least one electrical contact and extend to an area of the interposer substrate away from the radio frequency identification circuit. In various embodiments the interposer is recessed at least partially into an embossed depression in the surface of the container substrate. The embossed depression may have a negative profile of the interposer.

In the exemplary embodiment, the interposer includes an adhesive coupled to a side of the interposer substrate opposite the radio frequency identification circuit such that the interposer is coupled to the container substrate using the interposer adhesive with relatively light pressure applied to the interposer. In an alternative embodiment, an adhesive is applied to the container substrate for coupling the interposer to the container substrate.

The container substrate may include, for example, a linerboard material, a plastic container, and/or other product container materials that are compatible with relatively high speed container fabrication and printing assembly lines such that are found in a box plant or processing facility.

After the interposer is coupled to the container substrate an antenna is transferred or printed 304 over at least a portion of the interposer lead such that the antenna and the radio frequency identification circuit are communicatively coupled. In the exemplary embodiment, a preprint printing press or other off-line printing press upstream of the corrugator is used. Ink used to print the antennae is electrically conductive, for example, ink that incorporates metals, such as copper, aluminum and/or silver. Inks incorporating organic conducting polymers may also be used. In the exemplary embodiment, the ink is Parmod® VLT Ink SSA-400 commercially available from Parelec of Rocky Hill, N.J. 08553.

The antenna is printed using a lithographic or flexographic press, but any suitable printing technology can be used, such as rotogravure, rotary screen printing, ink jet printing, and pad printing. One or more conductive layers are printed if a thicker antenna is desired. Alternatively, a non-conductive primer layer can be used prior to printing the conductive ink. In an embodiment, non-conductive (dielectric) layers are interposed between the conductive layers. The conductive antenna could also be sprayed onto the substrate, using a mask to define the shape of the antenna. Additionally, drop-on-demand inkjet technology and continuous inkjet technology may be used to apply the conductive ink. The antenna may also be transferred from a release substrate by pressure and/or by thermal transfer.

The linerboard is, for example, clay coated, high holdout linerboard, or regular linerboard. The quality of the printed antenna may vary according to the linerboard or substrate used and the printing technology employed. Applying the conductive antenna on linerboard upstream from the corrugator facilitates obtaining a uniform print. After the linerboard has been combined with corrugating medium in the corrugator, it is more difficult to ensure a uniform ink laydown due to variations of absorbency due to a “washboarding” effect that occurs in the corrugator.

In various embodiments of the present invention, an overprint varnish (OPV) is applied over the printed antenna. At least some known inks require exposure to temperatures of at least 150° C. to enable the full conductive properties to be obtained. The OPV may, for example, protect the printed antenna from damage as it passes through a dryer, enable the conductive ink to “cure”, and protect the antenna from damage during the remaining converting and other operations expected to occur in the supply chain. Additionally, the OPV may provide antistatic protection to the radio frequency identification circuit using antistatic additives incorporated into the OPV composition. Alternatively, a film patch is used in place of the OPV. When existing process heat sources are unavailable and/or inadequate for curing the printing ink, or other curing methods are required, for example, ultraviolet (UV) or electron beam (EB), additional heat sources, and additional equipment is added to the printing press and or corrugate machine.

The embossed depression and interposer are optically located using a sensor, for example, an electric eye or a video camera. A controller communicatively coupled to the optical sensor may process the image of the embossed depression and/or interposer as the container substrate passes proximate the optical sensor to detect features of the embossed depression and/or interposer that are characteristic to the electrical lead. The controller then may index the antenna print or application device such that the antenna is printed at least partially over the electrical lead coupled to the radio frequency identification circuit. The antenna is applied to the electrical lead such that radio frequency energy received by the antenna is transmitted to the radio frequency identification circuit and radio frequency energy received from the radio frequency identification circuit is transmitted to a RFID reader.

Although the embodiments described herein are discussed with respect to supply chain packaging material, it is understood that the RF-enabled transponder assembly and processing methodology described herein is not limited to supply chain packaging applications, but may be utilized in other non-packaging applications.

It will be appreciated that the use of first and second or other similar nomenclature for denoting similar items is not intended to specify or imply any particular order unless otherwise stated.

The above-described embodiments of an RFID transponder assembly provide a cost-effective and reliable means for mass production speed assembly of RFID-enabled transponders for consumer, commercial, and industrial packaging material applications. More specifically, coupling RFID interposers to a container substrate and then overprinting an antenna onto the interposer and container substrate during fabrication of packaging structures permits high speed production of supply chain packaging with RFID components applied during fabrication. As a result, the described methods and systems facilitate in-line RFID transponder assembly in a cost-effective and reliable manner.

Exemplary embodiments of RFID transponder methods and apparatus are described above in detail. The RFID transponder assembly components illustrated are not limited to the specific embodiments described herein, but rather, components of each imaging system may be utilized independently and separately from other components described herein. For example, the RFID transponder assembly components described above may also be used in combination with different in-line RFID transponder components. A technical effect of the various embodiments of the systems and methods described herein include facilitating assembly of RF enabled packaging materials at production level speeds.

While the invention has been described in terms of various specific embodiments, those skilled in the art will recognize that the invention can be practiced with modification within the spirit and scope of the claims.

What is claimed is:

1. A radio-frequency identification (RFID) transponder comprising:
a container substrate;
an interposer comprising:
an interposer substrate;
at least one electrically conductive lead coupled to said interposer substrate; and
a radio frequency identification circuit electrically coupled to said at least one interposer lead; and
a printed antenna communicatively coupled to said at least one interposer lead, said printed antenna comprising electrically conductive ink, at least a portion of said printed antenna coupled to said container substrate, said antenna configured to receive radio frequency energy from an RFID reader and radiate radio frequency energy received from the radio frequency identification circuit.

2. An RFID transponder in accordance with claim 1 wherein said container substrate comprises at least one of a linerboard for a corrugated structure and a plastic container.

3. An RFID transponder in accordance with claim 1 wherein said container substrate comprises a depression having a negative profile of said interposer embossed in a surface of said substrate.

4. An RFID transponder in accordance with claim 3 wherein said interposer is coupled to said container substrate at least partially within said depression.

5. An RFID transponder in accordance with claim 3 wherein said radio frequency identification circuit comprises at least one electrical contact, said interposer coupled to said container substrate such that said electrical contact is oriented away from said container substrate.

6. An RFID transponder in accordance with claim 1 wherein said interposer is coupled to said container substrate using an adhesive applied to said interposer.

7. An RFID transponder in accordance with claim 1 wherein said interposer is coupled to said container substrate using an adhesive applied to said container substrate.

8. An RFID transponder in accordance with claim 1 wherein said antenna is printed using a conductive ink comprising at least one of copper, aluminum, silver, and organic conducting polymers.

9. An RFID transponder in accordance with claim 1 wherein said antenna is printed using at least one of a plurality of layers of conductive ink, and a plurality of conductive ink layers and dielectric layers.

10. An RFID transponder in accordance with claim 1 wherein said antenna covers at least a portion of the interposer.

11. A radio-frequency identification (RFID) enabled product container comprising:
a container external surface;
an interposer comprising:
an interposer substrate;
at least one electrically conductive lead coupled to said interposer substrate; and
a radio frequency identification circuit electrically coupled to said at least one interposer lead; and
a printed antenna communicatively coupled to said at least one interposer lead, said printed antenna comprising electrically conductive ink, said antenna configured to receive radio frequency energy from an RFID reader and radiate radio frequency energy received from the radio frequency identification circuit.

12. An RFID enabled product container in accordance with claim 11 wherein said container external surface comprises at least one of a linerboard for a corrugated structure and a plastic container.

13. An RFID enabled product container in accordance with claim 11 wherein said container external surface comprises a depression having a negative profile of said interposer embossed in said container external surface.

14. An RFID enabled product container in accordance with claim 13 wherein said interposer is coupled to said container external surface at least partially within said depression.

15. An RFID enabled product container in accordance with claim 13 wherein said radio frequency identification circuit comprises at least one electrical contact, said interposer coupled to said container external surface such that said electrical contact is oriented away from said container external surface.

16. An RFID enabled product container in accordance with claim 11 wherein said interposer is coupled to said container external surface using an adhesive applied to said interposer.

17. An RFID enabled product container in accordance with claim 11 wherein said interposer is coupled to said container external surface using an adhesive applied to said container external surface.

18. An RFID enabled product container in accordance with claim 11 wherein said antenna is printed using a conductive ink comprising at least one of copper, aluminum, silver, and organic conducting polymers.

19. An RFID enabled product container in accordance with claim 11 wherein said antenna is printed using at least one of a plurality of layers of conductive ink, and a plurality of conductive ink layers and dielectric layers.

20. An RFID enabled product container in accordance with claim 11 wherein said antenna covers at least a portion of the interposer.

21. A method of forming an RFID transponder comprising:
coupling an interposer to a container substrate, the interposer including:
an interposer substrate;
a radio frequency identification circuit having at least one electrical contact extending from a first surface of the radio frequency identification circuit, the radio frequency identification circuit coupled to the interposer substrate such that the at least one electrical contact is oriented away from the interposer substrate; and
an interposer lead communicatively coupled to the at least one electrical contact, the interposer lead extending to an area of the interposer substrate away from the radio frequency identification circuit; and
printing an antenna over at least a portion of the interposer lead such that the antenna and the radio frequency identification circuit are communicatively coupled.

22. A method in accordance with claim 21 further comprising embossing a depression into a surface of the container substrate with a negative profile of the interposer.

23. A method in accordance with claim 22 wherein coupling an interposer to a container substrate comprises coupling the interposer to the container substrate such that the interposer is at least partially within the embossed depression.

24. A method in accordance with claim 22 wherein coupling an interposer to a container substrate comprises coupling the interposer to the container substrate such that the electrical contact is oriented away from the substrate.

25. A method in accordance with claim 21 wherein the interposer includes an adhesive, and wherein coupling an interposer to a container substrate comprises coupling the interposer to the container substrate using the interposer adhesive.

26. A method in accordance with claim 21 further comprising applying an adhesive to the container substrate for coupling the interposer to the container substrate.

27. A method in accordance with claim 21 wherein the container substrate includes at least one of a linerboard material and a plastic container, and wherein said coupling an interposer to a container substrate comprises coupling the interposer to at least one of the linerboard material and the plastic container.

28. A method in accordance with claim 21 wherein printing an antenna comprises printing the antenna using a plurality of dielectric layers.
